(19) United States
(12) Patent Application Publication
(10) Pub. No.: US 2002/0030831 A1
(43) Pub. Date: Mar. 14, 2002

(54) Image correction method

(75) Inventor: Naoto Kinjo, Kanagawa (JP)

Correspondence Address: SUGHRUE MION ZINN MACPEAK & SEAS, PLLC, 2100 Pennsylvania Avenue, NW, Washington, DC, 20037-3213, US

(73) Assignee: FUJI PHOTO FILM CO., LTD.

(21) Appl. No.: 09/852,301

(22) Filed: May 10, 2001

(30) Foreign Application Priority Data
May 10, 2000 (JP) 2000-136642

(51) Int. Cl. G06K 15/12; H04N 1/407; H04N 1/409

(52) U.S. Cl. 358/1.9; 358/527

(57) ABSTRACT

There is provided an image correction method which enables even an operator who does not have sufficient knowledge and experience to speedily and properly correct an image by simple operations and to efficiently perform correction operations according to operator's sensibilities or the like. Verbal expressions representing conditions of an image or directions of corrections of the image, and image correction conditions corresponding to the verbal expressions are set in advance. At least one of the verbal expressions is input as a correction instruction with respect to an image. The image is corrected under the corresponding image correction condition.

### BACKGROUND OF THE INVENTION

1. Field of the Invention

The present invention relates to the technical field of image processing and, more particularly, to an image correction method which enables correction of an image with improved facility and operability in a checking and setting process or the like in a laboratory.

2. Description of the Related Art

Presently, the dominating method of printing on a photosensitive member (photographic paper) an image photographed on a photographic film such as a negative film or a reversal film (hereinafter referred to simply as “film”) is a direct exposure method in which an image formed on a film is projected onto a photosensitive member to perform exposure on the photosensitive member.

On the other hand, digital photoprinters using digital exposure have recently been put to practical use.

Basically, a digital photoprinter comprises a scanner (image reader) which makes reading light pass through a film as projected light and reads the projected light to photoelectrically read an image recorded on the film, an image processor which performs predetermined kinds of processing on input image data obtained by reading with a scanner or input image data supplied from a digital camera or the like to form output image data for image recording, i.e., exposure conditions, in order to output a print (correct print) in which the original image is correctly reproduced, and a printer (image recorder) which records a latent image on a photosensitive member by exposing the photosensitive member with, for example, a scanning beam of light according to image data output from the image processor, and performs a development process on the latent image to obtain a print (photograph) in which the original image is reproduced.

The thus-arranged digital photoprinter is capable of processing (optimizing) an image through processing of data on the image and can, therefore, obtain a print of high qualities, which is not attainable by the conventional direct exposure, if it suitably performs gradient adjustment, color balancing, color/density adjustment, etc.

As described above, the digital photoprinter performs image processing of image data to output a correct print. On the other hand, an ordinary photoprinter which performs ordinary direct exposures also performs image processing by adjusting the quantity of projected light to which a photosensitive member (photographic paper) is exposed and by inserting color filters in order to output a correct print.

The photoprinter is arranged to check whether the image processing is correct, in other words, whether a correct print can be output, and to perform a process for correcting the image if necessary (i.e., adjustment of image processing conditions). That is, the photoprinter is arranged to check and set image processing conditions.

Either the digital or direct-exposure photoprinter ordinarily set image processing conditions by photoelectrically reading an image on a film with a charge-coupled device (CCD) sensor or the like to obtain data on an image to be formed in a print, and by analyzing the obtained image data (image analysis).

Checking and setting image processing conditions are ordinarily performed by using an image supposed to be obtained as a finished image, i.e., a simulated image, such that image data on an image read with the CCD sensor is processed under set image processing conditions, and a visible image is reproduced on a display on the basis of the processed image data.

When an operator determines that the reproduced simulated image is not correct, a process for correcting the image is performed. To speedily and properly perform image correction, however, special knowledge and experience are required.

For example, image color correction is ordinarily performed by using three color adjustment keys for adjustment of three colors cyan (C), magenta (M) and yellow (Y), a plus (increment) key and a minus (decrement) key (the last two keys hereinafter referred to collectively as “change key”). With respect to each color, a certain number of adjustment steps, about fifteen, i.e., −7 key-in step to +7 key-in step, are provided.

However, it is extremely difficult to grasp how an image is changed (corrected) by a change in the level of each of colors relative to those of the other colors. It is necessary for a person to have long experience and expertise knowledge to become an operator capable of accurately determining the amount of correction using these keys. A considerably long time is required for an operator not sufficiently experienced and skilled in this operation to correct an image by the process of checking and setting image processing conditions.

The photoprinter also has, in addition to the color adjustment keys, other various adjustment keys such as a gradient (γ) adjustment key, a contrast adjustment key, a density adjustment key, and a sharpness adjustment key. To perform image correction, each of these keys is also used in combination with change keys, as is each color adjustment key. Also in the case of image correction using each of these keys, knowledge and experience at high levels are required to accurately determine how an image is to be corrected, and to suitably correct the image.

### SUMMARY OF THE INVENTION

In view of the above-described problems of the conventional art, an object of the present invention is to provide an image correction method which enables even an operator who does not have sufficient knowledge and experience to speedily and properly correct an image by simple operations in checking and setting conditions of image processing with a photoprinter or the like, and which enables the operator to efficiently perform correction operations according to operator's sensibilities or the like.

In order to attain the object described above, the present invention provides an image correction method comprising the steps of: previously setting at least one verbal expression representing a condition of an image or a direction of correction of the image, and at least one image correction condition corresponding to the verbal expression; inputting the verbal expression as a correction instruction according to the image; and correcting the image under the corresponding image correction condition according to the input verbal expression.

Preferably, a plurality of image correction conditions of different intensities are set with respect to the verbal expression, and a plurality of images corrected under the image correction conditions are reproduced according to the input verbal expression.

Preferably, a relationship between the verbal expression first input with respect to the image and correction of the image finally made is totalized, and the image correction condition corresponding to the verbal expression is updated according to a result of totalization.

Preferably, image scenes of the images are sorted by using image characteristic values of the images and the totalization is performed for each of the image scenes sorted.

Preferably, when the image is reproduced on a photographic print, the image is sorted according to at least one of printing method, type of printing paper, printer model, individual printer used, operator using the printer, and laboratory store concerned, before the relationship between the verbal expression first input and the correction of the image finally made is totalized for each sorting process so as to update the image correction condition corresponding to the verbal expression according to the result of the totalization.

Preferably, a plurality of image correction conditions having different image correcting algorithms are set with respect to the verbal expression; image correction is performed by selecting one of the image correction conditions; a number of times each of the image correction conditions is selected is totalized; and a priority order of each of the plurality of image correction conditions is updated according to a result of totalization.

Preferably, a condition setting algorithm of image processing is updated according to the result of the totalization.

Preferably, density control according to a result of extraction of an essential portion is included as image processing, and recomputation of an amount of density control according to the result of extraction of the essential portion is included as an image correction according to the verbal expression.

Preferably, in correction processing of the image, switching is performed between a verbal input mode for inputting the verbal expression and a numerical input mode to input the correction instruction.

### BRIEF DESCRIPTION OF THE DRAWINGS

In the accompanying drawings:

FIG. 1 is a block diagram of a digital photoprinter using an image processing unit of the present invention;

FIG. 2 is a block diagram of the image processing unit of the digital photoprinter shown in FIG. 1;

FIG. 3 is a diagram for explaining an example of the image correction method of the present invention; and

FIG. 4 is a diagram for explaining another example of the image correction method of the present invention.

### DETAILED DESCRIPTION OF THE PREFERRED EMBODIMENT

An image correction method of the present invention will be described below in detail with reference to a preferred embodiment shown in the accompanying drawings.

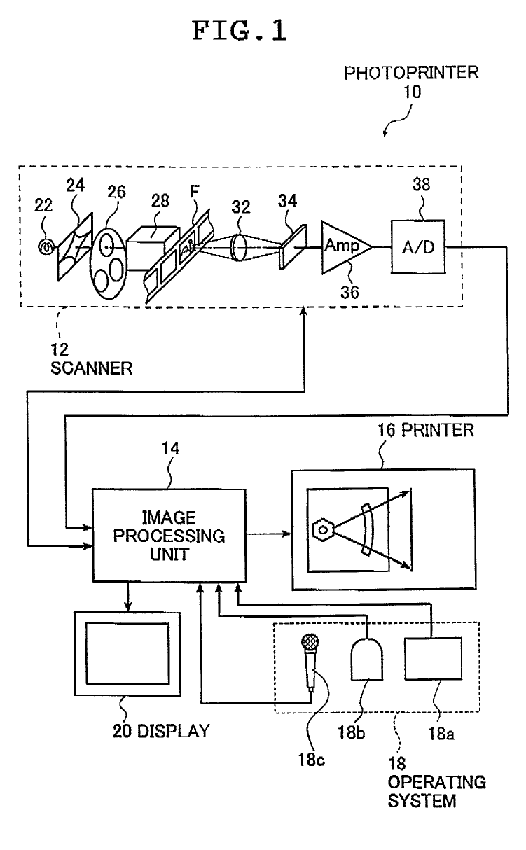

FIG. 1 is a block diagram schematically showing an exemplary digital photoprinter using the image correction method of the present invention.

The digital photoprinter shown in FIG. 1 (hereinafter referred to as “photoprinter”) 10 basically comprises a scanner 12 for photoelectrically reading original images recorded on a (photographic) film F, an image processing unit 14 which performs image processing on image data read by the scanner 12, and which performs overall control of the photoprinter 10, etc., and a printer 16 which performs exposure of a photosensitive member (photographic paper) with light beams modulated in accordance with image data processed by the image processing unit 14, performs a development process and outputs a print (photograph).

To the image processing unit 14 are also connected an operating system 18 having a keyboard 18a and a mouse 18b for selecting various kinds of processing for inputting instructions relating to processing, instructions relating to color/density correction, etc., and a display 20 for displaying a simulated image, etc., for checking and setting. In a preferred example of implementation of the illustrated photoprinter 10, image correction instructions in the form of speech can be input. The operating system 18 includes a microphone 18c for inputting speech instructions.

The scanner 12 is a unit for photoelectrically reading each of frames of photographic image photographed on a film F. The scanner 12 has a light source 22, a variable diaphragm 24, a color filter plate 26 having red (R), green (G) and blue (B) color filters successively placed operably across an optical path, a diffuser box 28 for uniformly diffusing reading light traveling to the film F, an imaging lens unit 32, an (area) COD sensor 34 for reading each frame on the film, an amplifier 36, and an analog-to-digital (A/D) converter 38.

Carriers (not shown) specially designed to support different types of film varying in size, e.g., the 135-size film and the film in the Advanced Photo System (APS) are prepared. Each carrier is detachably loaded in the body of the scanner 12. The loaded carrier is interchanged to adaptively set each of different types of film and to enable each of various kinds of processing.

The carrier transports the film F such that each of the frames (images) photographed on the film F is successively set at a predetermined reading position when the frame is read.

In the thus-constructed scanner 12, reading light is emitted from the light source 22, quantity-adjusted by the variable diaphragm 24, color-adjusted when passing through the color filter plate 26, and is diffused by the diffuser box 28 before it is incident upon the film F. The reading light passes the film F to form projected light carrying the image in the frame on the film F at the reading position.

The projected light from the film F is focused on the light receiving surface of the CCD sensor 34 by the imaging lens unit 32 to be photoelectrically read by the CCD sensor 34. The output signal from the CCD sensor 34 is amplified by the amplifier 36 and is converted into a digital signal by the A/D converter 38 to be sent to the image processing unit 14.

In the scanner 12, the above-described image reading is performed three times by successively inserting the color filters of the color filter plate 26 to decompose the one-frame image into three primary colors R, G, and B, thus reading the image.

The scanner 12 performs two image reading processes: a prescanning process in which the image photographed on the film F is read at a low resolution, and a fine-scanning process for obtaining image data for forming an image to be output. A prescan is performed under conditions set for prescan reading such that the CCD sensor 34 can read all the images scanned by the scanner 12 without being saturated. On the other hand, a fine scan is performed under conditions set from prescan data for fine scan reading with respect to each frame such that the CCD sensor 34 is saturated at a density slightly lower than the minimum of the density of the image (frame). Therefore, the output signals respectively obtained from the same image by the prescan and the fine scan differ from each other in resolution and in output level.

In the photoprinter 10 to which the present invention is applied, the scanner 12 is not limited to the above-described arrangement. The photoprinter 10 may use any other type of scanner, e.g., one in which a line CCD sensor adapted to reading of each of R, G and B images is used to photoelectrically read each image on the film while the image is scanned with slit scanning light, or one in which R light, G light and B light are successively led to the film to decompose the image on the film into three primary colors to enable photoelectrical reading of the image without the color filter plate.

Also in the photoprinter 10 to which the present invention is applied, prints can be formed not only from images photographed on film F but also from image data recorded on a recording medium such as a compact disc recordable (CD-R), on which data on images in prints which has been output together with prints from a (digital) photoprinter has been recorded, from image data obtained by photographing with various image pickup devices such as digital cameras, and from image data supplied from a computer or a communication network.

As mentioned above, the output signal (image data) from the scanner 12 is supplied to the image processing unit 14.

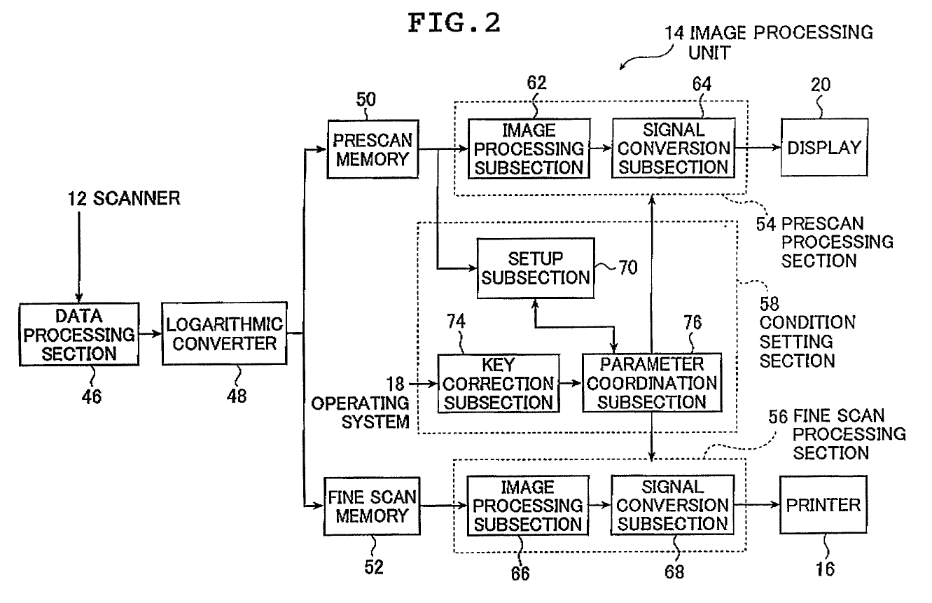

As shown in FIG. 2, the image processing unit 14 (hereinafter referred to as “processor 14”) comprises a data processing section 46, a logarithmic converter 48, a prescan (frame) memory 50, a fine scan (frame) memory 52, a prescan processing section 54, a fine scan processing section 56, and a condition setting section 58.

FIG. 2 mainly shows sections relating to image processing. The processor 14 also comprises other sections, e.g., a central processing unit (CPU) for overall control and management of the entire photoprinter 10 including the processor 14.

Each of R, G, and B output signals from the scanner 12 undergoes predetermined processing for DC offset correction, dark correction, shading correction, etc. The signal thereby processed is converted into digital image data by the logarithmic converter 48. Prescan (image) data after this conversion is stored (held) in the prescan memory 50, and fine scan (image) data is stored (held) in the fine scan memory 52.

The prescan data stored in the prescan memory 50 is processed by the prescan processing section 54, and the fine scan data stored in the fine scan memory 52 is processed by the fine scan processing section 56.

The prescan processing section 54 comprises an image processing subsection 62 and a signal conversion subsection 64. On the other hand, the fine scan processing section 56 comprises an image processing subsection 66 and a signal conversion subsection 68.

Each of the image processing subsection 62 in the prescan processing section 54 and the image processing subsection 66 in the fine scan processing section 56 is a section for performing image processing on an image (image data) read by the scanner 12 according the setting determined by the condition setting section 58. The processing subsections 62 and 66 perform basically the same processing except that the groups of image data thereby processed differ in pixel density.

Image processing in each of the image processing subsections 62 and 66 is at least one of well-known various kinds of image processing, for example, gray balancing, gradient adjustment, density adjustment, electronic enlargement/reduction processing, sharpness (sharpening) processing, granulation suppression processing, smoothing processing, dodging processing (corresponding to processing for producing a dodging effect by image data compression maintaining intermediate grayscale levels in a direct-exposure photoprinter), and red-eye correction.

Each of these kinds of processing may be performed on the basis of a well-known method and may be performed as a suitable combination of some of processing computation (algorithm), processing using an adder or subtracter, processing using a look-up table (LUT), matrix (MTX) computation, processing using a filter, etc.

For example, each of gray balancing, density adjustment and gradient adjustment is performed by a method using a LUT formed according to image characteristic values, saturation adjustment is performed by a method using MTX computation, sharpness processing is performed by a method in which an image is separated into frequency components, a brightness signal obtained from medium and high frequency components is multiplied by a sharpness gain (sharpness correction coefficient) and the brightness information thereby obtained is added to low-frequency components, and smoothing processing is performed by a method of averaging image data with a mask.

The signal conversion subsection 64 in the prescan processing section 54 is a portion for converting image data processed by the image processing subsection 62 into a form suitable for the display 20 by referring to a three-dimensional (3D)-LUT or the like.

On the other hand, the signal conversion subsection 68 in the fine scan processing section 56 is a portion for converting image data processed by the image processing subsection 66 into a form suitable for image recording with the printer 16 by referring to a three-dimensional (3D)-LUT or the like.

Kinds of image processing performed by the prescan processing section 54 and the fine scan processing section 56 and image processing conditions under which the processing is performed in each of these sections are set by the condition setting section 58.

The condition setting section 58 comprises a setup subsection 70, a key correction subsection 74, and a parameter coordination subsection 76.

The setup subsection 70 is a portion for determining conditions of fine scan reading, conditions of image processing in the image processing subsection 62 in the prescan processing section 54, conditions of image processing in the image processing subsection 66 in the fins scan processing section 56, etc.

More specifically, the setup subsection 70 forms a density histogram from prescan data, computes image characteristic values, such as an average density, a highlight level (minimum density), and a shadow level (maximum density), extracts essential subjects, sets fine scan reading conditions, as mentioned above, and determines conditions of image processing in the image processing subsections 62 and 66 according to the density histogram, the image characteristic values, instructions from an operator, etc. The setup subsection 70 supplies data on the determined conditions to the parameter coordination subsection 76.

The key correction subsection 74 is a portion for selecting image correction conditions according to instructions input through, for example, the microphone 18c in the operating system 18 to perform image correction such as color correction, density correction and contrast correction at the time of checking and setting, and for supplying data on the selected conditions to the parameter coordination subsection 76.

In the key correction subsection 74, expressions of conditions of an image are set with respect to a supposed finished image (simulated image) represented on the display 20 for checking. More specifically, verbal expressions of improper points of an image (e.g., “dense”, “thin”, etc.) and the degree of improperness (e.g., “a little”, “considerably”, “very” or the like) are set. Also, image correction conditions for modification of the verbal expressions are set, as described below in detail.

As mentioned above, the illustrated photoprinter 10 has the function of inputting image correction instructions in the form of speech. The key correction subsection 74 uses a well-known speech recognition device to recognize an image correction instruction supplied in the form of a speech with respect to the above-mentioned simulated image.

The parameter coordination subsection 76 receives image processing conditions, etc., computed by the setup subsection 70, and sets the conditions in predetermined places in the image processing subsections 62 and 66.

When an image correction instruction is input by the operator after checking the simulated image, the parameter coordination subsection 76 computes image data processing conditions for performing the image correction in accordance with the instruction, sets the computed conditions in the image processing subsections 62 and 66, and changes the image processing conditions previously set in the image processing subsections 62 and 66.

As described above, image data processed in the prescan processing section 54 of the processor 14 is sent to the display 20 while image data processed in the fine scan processing section 56 is sent to the printer 16.

In the photoprinter 10 to which the present invention is applied, the display 20 is not limited to any particular type. The display 20 may be any of well-known displays, e.g., a cathode ray tube (CRT), a liquid crystal display (LCD), or a plasma display.

The printer 16 comprises a printing unit for performing exposure of a photosensitive member (photographic paper) according to supplied image data to record a latent image, and a processing unit for performing predetermined processing on the exposed photosensitive member to output a (finished) print.

For example, the printing unit cuts the photosensitive member into pieces of a predetermined length according to output prints, performs back print recording, and performs latent image recording by two-dimensional scanning exposure on each piece of the photosensitive member in such a manner that each of three beams of R exposure light, G exposure light and B exposure light is modulated with image data output from the processor 14 and is deflected in a main scanning direction, and the photosensitive member is transported in an auxiliary scanning direction perpendicular to the main scanning direction. The printing unit supplies to the processing unit the photosensitive member on which the latent image is formed. The processing unit performs, on the supplied photosensitive member, a predetermined wet development process including color development, bleaching fixation and rinsing, and dries the photosensitive member obtained as a print. The printing unit forms a number of prints in the above-described manner and sorts and stacks unit batches of thus-obtained prints each corresponding to one roll of film.

The image correction method of the present invention will be described in detail through the following description of the operation of the photoprinter 10.

An operator loads in the scanner 12 the carrier adapted to the film F, sets the film F on the carrier, inputs various necessary instructions and information, and thereafter initiates the print forming process.

Predetermined conditions of the scanner 12, i.e., the quantity of light from the light source 22, etc., are checked, and the conditions of the scanner 12, including the aperture value of the variable diaphragm 24, are adjusted to prescan reading conditions. Prescanning is then started and the film F is transported to set first frame on the film F at the predetermined reading position.

When the first frame of the film F is set at the reading position, reading light emitted from the light source 22, adjusted by the variable diaphragm 24 and the color filter plate 26 and diffused by the diffuser box 28 is incident upon the first frame at the reading position and passes through the film F. Projected light from the film F carries the image formed in the frame and is focused on the CCD sensor 34 by the imaging lens unit 32 to be photoelectrically converted into an electrical signal, which is amplified by the amplifier 36 to be sent to the processor 14.

In the scanner 12, as described above, this image reading is performed three times by successively inserting the color filters of the color filter plate 26 to decompose the image on the film F into three primary colors R, G, and B.

Each of prescanning and fine scanning may be separately performed on one frame or may be continuously performed on all the frames or a predetermined number of frames in the frames on the film. An example of prescanning and fine scanning separately performed on each frame will be described for the sake of clarity of explanation.

The output from the CCD sensor 34 is amplified by the amplifier 36 and is converted into a digital signal by the A/D converter 38. The converted digital signal is supplied to the processor 14, undergoes predetermined processing for offset correction, etc., in the data processing section 46, and is converted into digital image data by the logarithmic converter 48 to be stored in the prescan memory 50.

When prescan data is stored in the prescan memory 50, the setup subsection 70 reads out the prescan data, cuts out the image area corresponding to each of the frames, successively performs forming a density histogram, computing image characteristic values, etc., with respect to each frame, as described above, sets conditions, e.g., the aperture value of the variable diaphragm 24 for fine scan reading of each frame from the results of these kinds of processing, and sends the set conditions to the scanner 12.

Further, the setup subsection 70 sets image processing conditions according to the density histogram, the image characteristic values, etc., and sends the set image processing conditions to the parameter coordination subsection 76. The parameter coordination subsection 76 sets the set image processing conditions in the predetermined places in the image processing subsection 62 in the prescan processing section 54 and the image processing subsection 66 in the fine scan processing section 56.

After the image processing conditions have been set in the image processing subsections 62 and 66, the prescan data is read out from the prescan memory 50, undergoes image processing in the image processing subsection 62 under the set image processing conditions, and is converted into image data suitable for the display 20 by the signal conversion subsection 64 to be displayed on the display 20.

The resulting image has been processed by the same image processing as that in the image processing subsection 66 in the fine scan processing section 56, and is displayed as an image supposed as a finished image reproduced in a print, i.e., a simulated image.

The operator checks the simulated image displayed on the display 20. The operator inputs a check OK instruction in the case of determining that the image is correct, and Age inputs an image correction instruction in the case of determining that the image needs correction.

As mentioned above, in a preferred example of implementation of the illustrated photoprinter 10, image correction instructions can be input as speech inputs through the microphone 18c.

In the present invention, however, the method of inputting image correction instructions is not limited to speech input, and any of other various well-known input methods may be used. For example, keys corresponding to verbal expressions described below may be provided in the keyboard 18a to input image correction instructions, the keyboard 18a may be operated to input words corresponding to verbal expressions described below, or verbal expressions described below may be input by using a graphical user interface (GUX) on the display 20 and by operating with the mouse 1b.

Further, correction instructions in the form of verbal expressions described below may be written with an electronic pen or the like through a GuI. In such a case, the electronic pen or the like may be operated to cut out a portion to be corrected and to input a correction instruction in the form of letters or a symbol. The letters or the symbol is recognized by a well-known recognition device to enable correction in accordance with the instruction represented by the letters or symbol.

Correction instructions may be input by selecting one input device or using a plurality of input devices in combination.

In the present invention, correction instructions may not be limited to a simulated image.

For example, a correction instruction to correct the color, density, etc., of a print previously output is received from a customer and the corresponding image is reprinted in accordance with the instruction. In the case of reprinting, the image in the print previously output may be used to input a correction instruction without displaying a simulated image.

As mentioned above, in the key correction subsection 74 of the photoprinter 10 to which the present invention is applied, expressions of improper points (hereinafter referred to as “indicated matters”) of image and expressions of the degree of improperness (hereinafter referred to simply as “degree”) are stored in advance in a suitably combined state as verbal expressions (hereinafter referred to as “expression”) for expressing image conditions of simulated images. In the key correction subsection 74 are also stored image correction conditions relating to the set image condition expressions.

In the illustrated photoprinter 10, some of these image condition expressions is input to provide an image correction instruction.

Words for expressing indicated matters are not particularly limited and various words expressing improper points of images can be used. For example, expressions relating to the density, e.g., “dense”/“thin”, expressions relating to color tones, e.g., “blue”/“red”/“yellow” are used. Further, indications relating to portions of an image, e.g., “red eye” and “the person at the center looks pale” may be given.

For expression of the degree, expressions on three levels “a little”, “considerably”, and “very” are provided, for example. Expressions of the degrees are not limited to those on three levels, and intensity expressions on two levels, four levels or some larger number of levels may be provided as expressions of the degree.

That is, in this embodiment, expressions such as “(image is) considerably dense” and “a little yellowish” are input as correction instructions according to image conditions.

In the key correction subsection 74, as mentioned H-above, image correction conditions are set according to set image conditions. For example, when an indicated matter “dense” is input, an image correction condition for reducing the density is set. When an indicated matter “bluish” is input, an image correction condition for reducing blueness (e.g., by increasing yellow) is set. When an indicated matter “the person at the center looks pale” is input, flesh color correction of a face area is performed according to the result of face extraction (face extraction is performed if face extraction has not been set as an image processing default). In this collection, the operator may designate the face area by using a GUI, for example.

Image correction conditions are set with respect to indicated matters in such a manner that a small amount of correction is made when “a little” is input as a degree, a substantial amount of correction is made when “considerably” is input, and a large amount of correction is made when “very” is input.

The embodiment has been described with respect to a preferred mode of implementation in which an indicated matter and a degree are input as an image condition. However, the present invention is not limited to this mode of implementation. The arrangement may be such that only an indicated matter is input as an image condition, and the key correction subsection 74 selects an image correction condition according to this image condition to perform image correction. In such a case, “dense, may be input if it is determined that the image is dense, as described above, and “dense” may be again input if it is determined that the image is still dense after correction.

The operation will be described with respect to an example of input of an indicated matter “thin”. The same description may also apply to inputs (correction instructions) of other indicated matters relating to the colors and the density (and further to various indicated matters described below).

With respect to an indicated matter “thin”, an image correction to increase the image density is of course made.

In the illustrated photoprinter, fifteen density adjustment steps (−7 (key) to 0 (key), and 0 to +7 (key)) are set. Symbol “−” denotes decrement and symbol “+” denotes increment. Accordingly, as shown in Table 1, seven density increase steps (+1 to +7) are set with respect to an indicated matter “thin”, and +1t”, “+4”, and “+6”, indicated by underlines, are set as basic default values with respect to “a little”, “considerably”, and “very”, respectively.

That is, when “a little thin” is input as an image condition, an increase of +1 in density is produced as an image correction. When “considerably thin” is input, an increase of +4 in density is produced. When “very thin” is input, an increase of +6 in density is produced.

TABLE 1

| | “A Little” | | | “Considerably” | | | “Very” | | |
|---|---|---|---|---|---|---|---|---|---|
| Indicated | ±1 | ±2 | ±3 | ±3 | ±4 | ±5 | ±5 | ±6 | ±7 |
| Matter | | | | | | | | | |
| “Thin” | | | | | | | | | |
| Categorized | 50 | 30 | 10 | 30 | 20 | 10 | 2 | 5 | 10 |
| Total | | | | | | | | | |

An image processing condition is adjusted according to an input image correction condition, and a relating simulated image on the display 20 is correspondingly changed, as described below in detail. For example, when a correction instruction using “considerably thin” is input, an simulated image increased in density by +4 is displayed.

When the operator determines that the density has been suitably corrected, he or she inputs a check OK instruction (or an image correction instruction with respect to a factor other than the density). When the operator determines that the density has not been suitably corrected, he or she again inputs “a little thin” or the like to further make a correction until the image density becomes correct. If there is a need to make a further correction after image correction of the simulated image, the operator may input a correction instruction by using a verbal expression such as “a little more”, “more”, “overshot”, or the like.

In the above-described example, one simulated image is displayed, a correction is made, and the correction steps are repeated if necessary. According to the present invention, a plurality of simulated images related to different amounts of correction (i.e., corrected images) may be displayed according to input of an image conditions, and the operator may select one of the simulated images regarded as correct to make the corresponding correction of the image to be obtained.

In this manner, the time required for checking and the amount of operator's work can be reduced to achieve more efficient printing.

For example, in the above-described example using +4 key-in as a density increase default, a simulated image representing the results of correction by increasing the density by +3 key-in and a simulated image representing the results of correction by increasing the density by +5 key-in are displayed on the display 20 together with a simulated image representing the results of +4 key-in correction. The photoprinter may be arranged so that the amount of correction and the number of corrections can be selected.

The operator checks the displayed simulated images resulting from the different amounts of correction, and selects one of the images in which the operator recognizes most preferable results to determine a correction condition with respect the density.

In this example, it is preferable that all the simulated images to be displayed should be simultaneously displayed on the display 20. However, if it is difficult to do so because of restrictions on the processing speed, the screen size of the display 20, etc., the simulated images may be displayed one frame or a plurality of frames at one time.

In this case, the simulated images may be changed in response to an NG instruction or the like input by the operator, for example.

According to the present invention, as is apparent from the above-described example, it is not necessary for the operator to particularly designate the kind of correction and one of the steps of the changing key, and the operator can correct an image by abstract verbal instructions.

In a preferred mode of implementation of the present invention, the relationship between an image condition first input by checking a simulated image and a correction finally made with respect to an indicated matter (correction instruction) input for correction of an image is recognized, and the relationships between image conditions and corrections thus recognized with respect to each of a plurality of indicated matters are totalized to update the image correction condition related to each image condition.

For example, a correction instruction “considerably thin” is first input and, after the corresponding correction of the simulated image, the operator inputs a correction instruction “a little thin” and then determines a check OK. In this case, the image density correction finally made is “(+4)+(+1)=(+5)”, and the number in the section corresponding to +5 is incremented with respect to “considerably” input first about the indicated matter “thin”. (In a case where a plurality of simulated images are displayed, the number in the section corresponding to the selected key is incremented).

In Table 1, only key-in values in the vicinity of each default value are shown for the sake of clarity of explanation. According to the present invention, however, the number of key-in values to be counted on each instruction is not limited.

Such totalization is performed with respect to a predetermined number of frames, for example. The extent of totalization is not particularly limited. It is determined according to the capacity, scale, or the like of a laboratory store. For example, totalization may be performed with respect to any amount of processing or number of frames, e.g., 1000 frames, or over any period of time, e.g., a month, one of the four seasons, or one year.

According to the results of totalization performed as described above, the default value with respect to each of the degrees “a little”, “considerably” and “very” is updated for the best match with the corrections finally made.

For example, in Table 1, +1 key-in from “a little” has the highest frequency of occurrence, +3 key-in from “considerably” has the highest frequency of occurrence, and +7 key-in from “very” has the highest frequency of occurrence. From these results of totalization with respect to a predetermined number of frames, the key-in value +1 is maintained as the default value related to “a little”, the default value related to “considerably” is changed to the key-in value +3, and the default value related to “very” is changed to the key-in value +7.

The above-described totalization may be performed in each of photoprinters 10 (laboratory stores) or may be performed with respect to each of operators who operate each photoprinter 10.

This arrangement ensures that a tendency of image correction according to a preference of each laboratory store or operator can be set as a default to reduce occurrences of an operation for again making a correction after the completion of one image correction process according to a simulated image, or to reduce the number of times of correction. That is, the printing process efficiency can be improved.

Also, totalization such as that described above may be performed with respect to geographic areas, as described below in detail.

Such totalization may be performed with respect to image scenes to enable updating of image correction conditions according to image conditions with respect to each scene.

Image scene sorting performed in such a case is not limited to a particular method. For example, sorting of ordinary scenes, overexposure scenes, and underexposure scenes may be performed by using at least one of two criteria obtained from a density histogram, a density distribution pattern and a difference between the densities of central and marginal image portions. Also, scene sorting based on a method of supposing a scene by using a face extraction result or a subject extraction result (e.g., sorting of portraits and scenery) is preferred. Further, scene sorting of portraits, scenery, night views, underexposure scenes, high-contrast scenes may be performed according to inputs provided by the operator. Two or more of the above-described kinds of sorting may be used together.

Further, such sorting or totalization may be performed according to at least one of the factors described below, namely according to one factor or combinations of two or more factors so that feedback can be made on the relationship between verbal expressions and image correction conditions.

That is, when images are reproduced on photographic prints, the images may be sorted according to at least one of the factors including printing method, type of printing paper, printer model, individual printer used, operator using the printer, and laboratory store (photo studio) concerned, before the relationship between the verbal expression first input and the image correction finally made is totalized for each of the images sorted so as to update the image correction condition corresponding to the verbal expression according to the result of the totalization.

Examples of the printing method include a silver halide photographic printing type and ink-jet printing type. In the type of printing paper are included paper type and paper surface type. Sorting and totalization are performed according to the printer model or individual printer used in order to remove machine-dependent differences.

Further, the setting algorithm used by the setup subsection 70 to set image processing conditions may be updated by using the results of totalization of image correction performed as described above. The extent of totalization may be set in the above-described manner.

For example, as shown in Table 2, corrections finally made with respect to indicated matters relating to the density, i.e., the above-described “thin” and “dense”, (an increase of +5 in density in the above-described example) are totalized. In Table 2, “0” designates the case where no density correction is made after checking, i.e., the case where the density adjustment condition set by the setup subsection 70 is correct. In the illustrated example, correction steps from −7 to +7, that is, a total of fifteen steps are set, as described above. However, the possibility of correction by an amount exceeding ±3 after checking is extremely low. Therefore data on such a case is omitted from Table 2.

In the totalization results shown in Table 2, with respect to this photoprinter 10 (or the operator operating this photoprinter 10), the frequency of occurrence of correction by +1 after checking is higher than that of correction by 0, i.e., non-correction. That is, a density lower by +1 than the correct density ordinarily results from the density adjustment condition set by the setup subsection 70.

TABLE 2

| | Contents of Corrections Made by Operator | | | | | | |
|---|---|---|---|---|---|---|---|
| | (Final Results) | | | | | | |
| Indicated | −3 | −2 | −1 | 0 | +1 | +2 | +3 |
| Matter | | | | | | | |
| Relating to | | | | | | | |
| Density | | | | | | | |
| Categorized | 0 | 2 | 5 | 20 | 40 | 20 | 10 |
| Total | | | | | | | |

Therefore, the setting algorithm used by the setup subsection 70 to set image processing conditions are updated so that the image processed under the condition set by the setup subsection 70 (before correction according to the checking result) has a density higher by +1 than the preceding density value.

In this manner, the frequency of image correction in the checking and setting process can be reduced to improve the printing process efficiency.

Examples of correction of the color or the density of an image have been described. Correction of the gradation, image structure or the like of an image can also be performed on the basis of the above-described method. Further, results of such correction may be totalized to enable updating of image correction conditions set as a default as well as updating of the algorithm for image processing condition setting performed by the setup subsection 70.

For example, “blurred”, “loud”, “sleepy”, “hard”, etc., are input as indicated matters, and the above-described three expressions “a little”, “considerably” and “very” are provided to indicate degrees.

For example, with respect to the indicated matter “fblurred”, an image correction is made such as to increase the effect of sharpness processing. With respect to the indicated matter “loud”, an image correction is made such as to increase the effect of smoothing processing. With respect to the indicated matter “sleepy”, an image correction is made such as to increase the contrast. With respect to the indicated matter “hard”, an image correction is made such as to reduce the contrast. The amount of each correction is changed according to the amount of input, as is that described above.

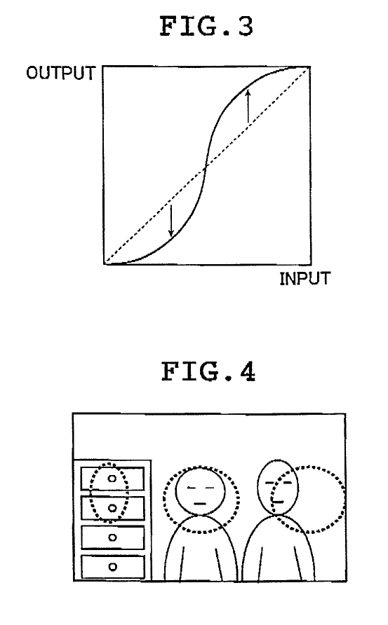

Contrast adjustment can be performed by adjusting a gradient adjustment characteristic curve (a corresponding lUT), for example. An image correction in contrast may be performed by increasing the gradient at an intermediate value on a characteristic curve when the contrast is to be heightened, as indicated by the arrows in FIG. 3.

The effect of sharpness processing or smoothing processing can be adjusted by selecting an N x N mask filter coefficient (sharpness gain). This coefficient may be set according to the amount of image correction.

For these kinds of image correction, a plurality of kinds of processing may be combined to set image processing conditions.

For example, with respect to the indicated matter “blurred”, an image correction may be made such as to heighten the contrast while the effect of sharpness processing is increased as described above. Correspondingly, as shown in Tables 3 and 4, M (e.g., seven) correction patterns which are characterized by different amounts of correction, and which are used to set levels of sharpness and levels of contrast enhancement are set with respect to the indicated matter “blurred”. Also, as shown in the underscored part of Table 4, the correction in accordance with the pattern 1 is set as a default with respect to an image condition expressed by “a little blurred”, correction in accordance with the pattern 4 is set as a default with respect to an image condition expressed by “considerably blurred”, and correction in accordance with the pattern 6 is set as a default with respect to an image condition expressed by “very blurred”.

When an image condition is input, an image correction is made in accordance with the corresponding correction pattern. Also with respect to this example, the above-described totalization may be performed.

TABLE 3

| Set Pattern | Contrast Enhancement | Sharpness Enhancement |
|---|---|---|
| Pattern 1 | Level 1 | Level 0 |
| Pattern 2 | Level 1 | Level 1 |
| . . . | . . . | . . . |
| Pattern M | Level p | Level q |

TABLE 4
Indicated Matter “Blurred”

| OK | 0 Level |
|---|---|
| “A Little” | Pattern 1 |
| | Pattern 2 |
| | Pattern 3 |
| “Considerably” | Pattern 3 |
| | Pattern 4 |
| | Pattern 5 |
| “Very” | Pattern 5 |
| | Pattern 6 |
| | Pattern 7 |

According to the present invention, as mentioned above, an image condition expressed by “red eye” may be input as an indicated matter to perform red-eye correction.

If, as in the case of red-eye correction, a plurality of correction methods (algorithms) are known, and if it is preferable to change operating algorithms according to image conditions, etc., a process may be performed in which the algorithms used for a number of image corrections on a predetermined number of frames are totalized with respect to different kinds of scene, and the priority with which each algorithm is used is changed according to the results of the totalization. The same process may be performed with respect to algorithm setting parameters.

For example, for red-eye correction, three red-eye correction algorithms: an algorithm (algorithm 1) in which a red-eye area is extracted according to color tone and shape determination to enable recognition and correction of red eye, an algorithm (algorithm 2) in which the same correction as that based on the algorithm 1 is performed with a parameter for broader red-eye recognition, and algorithm (algorithm 3) in which a red-eye area is extracted according to a lightness spatial distribution to enable red-eye correction are provided. Also, scenes are sorted into three groups according to large, medium and small color distributions in processed areas (i.e., according to the proportion of red-eye pixels).

After red-eye correction has been performed under these conditions, the algorithms used for red-eye correction processing on a predetermined number of frames are finally totalized with respect to each scene described above, the priority order of the algorithms as shown below in Table 5 is set with respect to each scene (the leftmost one with the highest priority), and then, with respect to each scene, the algorithm with priority according to the priority order is used to perform red-eye correction processing.

TABLE 5

| Sorting according to Color | |
|---|---|
| Distribution in Processed | |
| Area(Proportion of Red Pixels) | Priority Order |
| Large | Algorithm 2, Algorithm 1, |
| | Algorithm 3 |
| Medium | Algorithm 1, Algorithm 2 |
| | Algorithm 3 |
| Small (Gold Eye) | Algorithm 3, Algorithm 2, |
| | Algorithm 1 |

Further, according to the present invention, an image correction may be made in a case where, when density adjustment is performed by extracting a main subject, an undesirable image condition results due to erroneous extraction. In such a case, information on such a condition is input as a correction instruction, and according to the instruction, a density adjustment condition is recomputed to perform the correction.

That is, when main subject extraction is performed, the average density of a candidate area of a main subject extracted by the process is used to set a density adjustment condition. In a case where an incorrect density results from density adjustment due to erroneous extraction of a candidate area, the image condition is input as a correction instruction, the supposed correct value of the average density of candidate areas is computed according to the correction instruction, candidate areas having densities differing from the computed value by a value larger than a predetermined value are excluded, and density adjustment is performed by using the average density of the remaining areas.

For example, a situation will be considered in which three areas indicated by dotted lines in a photograph such as shown in FIG. 4 have been extracted as candidate areas for a face which is a main subject. That is, in this example, a chest of drawers is erroneously extracted as a face candidate area.

The density of the chest of drawers is higher than that of the face. Therefore, the average density of the face candidate areas is increased and the setup subsection 70 sets an image processing condition (density adjustment condition) such that the density of the face area is reduced. As a result, the density of the face area: correctly extracted is lower than that of the proper image.

The operator observing this simulated image inputs, if necessary, information that a face candidate area has been erroneously extracted and then inputs an image condition, for example, “considerably thin” as a correction instruction.

Accordingly, the area erroneously extracted and badly influencing the density adjustment can be identified from the relationship between the densities of the extracted areas and the ideal average density. When the image is in such a state that the density of face is “thin”, it is necessary to make a correction such as to increase the density of the face area. Ordinarily, the density of chests of drawers is higher than the ideal average density of faces. If the area recognized as erroneously detected is the face, a correction to increase the density further increases the improperness of the image. That is, the correction made on this area conflicts with the instruction from the operator, so that the area of the chest of drawers extracted as a face candidate area can be recognized as an erroneous extraction result.

Then, the face candidate extraction results other than this are used to recompute a density adjustment condition, thereby enabling correction of the image.

In the above-described example, an image condition is input as an image correction instruction after checking an image.

However, the present invention is not limited to this, and a direction of image correction expressed by a (verbal) expression may be input as an image correction instruction after checking an image. Also in such a case, image correction can be performed in the same manner as that in the above-described examples except that a different expression method is used.

The manner in which a correction direction is expressed is not particularly limited. Any expression specifying a correction with respect to the kind and extent of correction may suffice. For example, “reduce blueness a little”, “increase the density to a substantially high level”, “enhance the sharpness to an extremely high level”, etc., may be used. Alternatively, a correction instruction designating only the kind of correction to be executed, e.g., “reduce blueness” or “enhance the sharpness” may be provided.

An image correction condition may also be set in accordance with the image condition described above. For example, if the correction instruction is “reduce blueness a little”, Y may be set to +1. If the correction instruction is “increase the density to a substantially high level”, the density may be set to +4.

The conventional image correction method requires a concrete operation for definitely setting an amount of correction, etc., according to an image to be corrected, for example, an operation for designating the number of increasing key steps by which yellow is increased when the image is generally bluish, or designating the number of reducing key steps by which the density is reduced when there is a need to reduce the density, thus requiring experience and knowledge at high levels for performing correction properly as well as speedily.

In contrast, according to the present invention, it is not necessary for an operator to input a concrete correction instruction, and the operator can properly perform image correction by only inputting an image condition expressed as, for example, “considerably bluish”, and a correction direction expressed as, for example, “reduce blueness”. Thus, the present invention enables even an operator who does not have sufficient knowledge and experience to speedily and properly correct (check) an image and to produce prints with high productivity.

As described above, when the operator inputs an image correction instruction (an image condition or a correction direction), a correction signal or an adjustment signal is supplied to the key correction subsection 74. Needless to say, correction of an image after checking the image is not limited to one image condition (correction direction). For example, after the above-mentioned correction instruction using “a little thin” has been input, and after the correction of the density in accordance with this instruction has been completed, a correction instruction using “considerably sleepy” or the like may be input.

The key correction subsection 74 selects an image correction condition according to an image correction input and sends the image correction condition to the parameter coordination subsection 76. The parameter coordination subsection 76 sets, according to the supplied image processing condition, a processing condition for performing the correction in the image processing subsections 62 and 66, and corrects a previously set image processing condition. An image displayed on the display 20 is also changed according to the input provided by the operator.

The operator provides an output instruction by operating, for example, the keyboard 18a when determining, after checking the image on the display 20, that the image on the display 20 is correct (check OK).

Image processing to be performed on the frame (image) is thereby determined and fine scanning is started.

At the start of fine scanning, the aperture value of the variable diaphragm 24, etc., in the scanner 12 is adjusted to the set fine scan reading conditions. Fine scanning is performed in the same manner as prescanning except that the reading conditions and resolution differ from those at the time of prescanning. The output signal from the CCD sensor 34 is processed by the amplifier 36 and the A/D converter 38 and processed by the data processing section 46 of the processor 14, thereafter undergoing conversion in the logarithmic converter 48. The processed data obtained as fine scan data from the logarithmic converter 48 is sent to the fine scan memory 52.

After the fine scan data has been supplied to the fine scan memory 52, the fine scan data is read out by the fine scan processing section 56 to be processed under the determined image processing conditions in the image processing subsection 66, and then converted into output image data by the signal conversion subsection 68. The output image data is supplied to the printer 16, and the printer 16 outputs a print in which this image data is reproduced.

In the various kinds of image correction processing as described above, the operator provides correction instructions by inputting verbal expressions in the form of speech using the microphone 18c of the operating system 18 or by inputting verbal expressions using the keyboard 18a and the mouse 11b. However, this is not the sole case of the present invention. In order to enable the operator to input correction instructions, a verbal input mode for inputting verbal expressions and a conventional numerical input mode for directly inputting amounts of correction as numeric values are preferably provided together with a function for switching between these two modes.

The mode switching function may be a type in which an operator performs mode switching manually by using the keyboard 18a and the mouse 18b of the operating system 18, or a type in which, when an operator sets in the photoprinter 10 an ID card such as an employee's identification card or a card in which skill level is registered, a mode previously set in accordance with the operator's ID or skill level is automatically read out and the photoprinter 10 functions in this mode.

In such a manner, highly skilled (experienced) operators can use the numerical input mode, whereas operators having no sufficient knowledge or experience (newcomers) can use the verbal input mode for inputting verbal expressions. Thus, experienced persons can use one of these two modes and newcomers the other thereof. Of course, it becomes easier even for newcomers to operate in the numerical input mode once the skill is raised to a higher level. Alternatively, operation in the numerical input mode is more suitable for finer setting. Therefore, the more suitable of the two modes can be selected in accordance with the knowledge, experience or skill level of an operator or in accordance with the type of an image to be corrected, content of processing, operation or the like.

In the above-described embodiment, the results of image correction are totalized with respect to each of a plurality of photoprinters 10 or each of operators to update image correction conditions or image processing condition setting parameters (algorithm) according to a policy or a preference of the laboratory store or operator. However, the present invention is not limited to this. Similar totalization may be performed with respect to geographical areas or the four seasons to update the image processing conditions to enable correction in which a preference or a policy is reflected.

For example, if the photoprinter 10 has algorithms for image processing, image correction, etc., (the same algorithms repeatedly referred to below) set therein such that a flesh color in a finished print is suited to a Japanese people's taste, and if the same photoprinter model is used in European countries without changing the algorithms, there is a possibility of the corresponding color not being suited to a European people's taste. Also, if algorithms are set on the basis of photography under sunlight in Japan, and if the same photoprinter model having the same algorithms is used in a region largely different in latitude from Japan, prints obtained in such a region cannot be equivalent in quality to those obtained in Japan since sunlight in the region differs from that in Japan.

To solve this problem, data on the tendency of image correction in each of different regions is to be accumulated to update the algorithms.

For example, when an operator in a particular region operates the photoprinter to correct an image after checking the image, the correction results may differ from those obtained by operators in other regions with respect to the same sort of scene due to a preference of the operator in the particular region showing, for example, a tendency to contrast enhancement or reduction. In such a case, the parameters are to be changed according to such a tendency with respect to the particular region. Scene sorting may be performed in the same manner as the above-described example.

There are other examples of the method of updating the algorithms relating to the way in which the contrast is enhanced or the resolution (sharpness) is changed, changing the target value of the color tone or density of a human flesh color, etc.

This algorithms updating relating to flesh color is taken into consideration for the reason described below. It is considered that there are various colors favorably accepted as human flesh color by people in different regions. European people have a preference for a human face color lower in density than a flesh color selected on the basis of that of Asian people, and European operators tend to reduce the density of flesh color. Therefore, the algorithms are automatically set to update on the basis of a determination from accumulated data such that, after face extraction, the density is slightly reduced from the default value.

As described above, image corrections made by an operator are sorted with respect to a predetermined number of processed frames, connections of the corrections to particular sorts of scenes are examined, and the algorithms are optimized by being updated with respect to the predetermined number of frames so as to reflect statistical image correction tendencies with respect to the parameters on each of the predetermined sorts of scene. Preferably, the accumulated data is also updated to the latest data with respect to the predetermined number of frames.

In the above-described process, the sorts of scene and the data accumulation time are set with respect to each of the four seasons. For example, in a region surrounding or closer to a skiing area, a sort “snow scene” identified according to the highlight ratio in the scene may be added only in winter, and a “snow scene” may be given a gradient characteristic for enhancing whiteness.

In a certain region, laboratory stores in the region and a laboratory control center may be connected through a network, and the control center may perform an algorithm updating process on the entire region in such a manner that the control center collects information on corrections made by an operator in each laboratory store, grasps the total tendency of all the laboratory stores in the region, modifies the image processing algorithm of laboratory stores in the entire region at a certain timing, and distributes the updated algorithms to the laboratory stores.

In execution of the above-described process, data is recorded in combination with customer IDs to enable data management with respect to each customer, and the parameters may be optimized with respect to each customer.

The above-described process may be performed on printers in customers' houses instead of being performed on the photoprinters.

In the above-described embodiment, the image reproduction process is optimized according to various preferences of individual customers relating to scenes, which preferences vary with respect to localities and seasons.

Also, the present invention eliminates the need for separately setting, at the time of manufacture of the photoprinters, the parameters in the photoprinters according to the tendency at each of regions to which the photoprinters are exported, thereby facilitating the production shipment operations.

Also, the contents of requests may be separately reflected in the printing process and the monitor display process. Also, the present invention may be limited to particular frames and arranged to enable stoppage of processing of registered data and to enable designation of processing at particular requests.

The image correction methods of the present invention has been described in detail. Needless to say, the present invention is not limited to the above-described embodiment, and various changes and modifications of the embodiment may be made without departing from the scope of the invention.

While an application of the present invention to a digital photoprinter has been described, the present invention can also be applied to an ordinary direct-exposure photoprinter in which a photosensitive material is exposed to projected light from an image photographed on a film.

According to the present invention, as described above in detail, even an operator who does not have sufficient knowledge and experience can speedily and properly correct an image by simple operations in checking and setting conditions of image processing with a photoprinter or the like, and which enables the operator to efficiently perform correction operations according to operator's sensibilities or the like, thus improving the productivity of the process of forming a print (photograph) or the like.

What is claimed is:

1. An image correction method comprising the steps of:
previously setting at least one verbal expression representing a condition of an image or a direction of correction of the image, and at least one image correction condition corresponding to the verbal expression;
inputting the verbal expression as a correction instruction according to the image; and
correcting the image under the corresponding image correction condition according to the input verbal expression.

2. The image correction method according to claim 1, wherein a plurality of image correction conditions of different intensities are set with respect to the verbal expression, and a plurality of images corrected under the image correction conditions are reproduced according to the input verbal expression.

3. The image correction method according to claim 1, wherein a relationship between the verbal expression first input with respect to the image and correction of the image finally made is totalized, and the image correction condition corresponding to the verbal expression is updated according to a result of totalization.

4. The image correction method according to claim 3, wherein image scenes of the images are sorted by using image characteristic values of the images and the totalization is performed for each of the image scenes sorted.

5. The image correction method according to claim 3, wherein, when the image is reproduced on a photographic print, the image is sorted according to at least one of printing method, type of printing paper, printer model, individual printer used, operator using the printer, and laboratory store concerned, before the relationship between the verbal expression first input and the correction of the image finally made is totalized for each sorting process so as to update the image correction condition corresponding to the verbal expression according to the result of the totalization.

6. The image correction method according to claim 1, wherein a plurality of image correction conditions having different image correcting algorithms are set with respect to the verbal expression; image correction is performed by selecting one of the image correction conditions; a number of times each of the image correction conditions is selected is totalized; and a priority order of each of the plurality of image correction conditions is updated according to a result of totalization.

7. The image correction method according to claim 3, wherein a condition setting algorithm of image processing is updated according to the result of the totalization.

8. The image correction method according to claim 1, wherein density control according to a result of extraction of an essential portion is included as image processing, and recomputation of an amount of density control according to the result of extraction of the essential portion is included as an image correction according to the verbal expression.

9. The image correction method according to claim 1, wherein, in correction processing of the image, switching is performed between a verbal input mode for inputting the verbal expression and a numerical input mode to input the correction instruction.
